(19) United States
(12) Patent Application Publication
(10) Pub. No.: US 2004/0062315 A1
(43) Pub. Date: Apr. 1, 2004

(54) Device and process for time stamping, receiver, system for delayed broadcasting and string of corresponding packets

(76) Inventors: Philippe Leyendecker, Chateaugiron (FR); Pascal Maetz, Chevaigne (FR); Claude Rambault, Saint Sulpice la Foret (FR)

Correspondence Address: Joseph S Tripoli, Patent Operation, Thompson Multimedia Licensing, Inc, Po Box 5312, Princeton, NJ, 08543-5312, US

(21) Appl. No.: 10/451,832

(22) PCT Filed: Dec. 14, 2001
(86) PCT No.: PCT/EP01/14756

(30) Foreign Application Priority Data
Dec. 26, 2000 (FR) 00/17006

(51) Int. Cl. H04N 7/12

(52) U.S. Cl. 375/240.28; 375/240.25

(57) ABSTRACT

The present invention relates to a device and a process for the stamping in real time by means of a stamping clock (2) of programs, as well as to a receiver and a broadcasting system containing such a device and a packet string obtained by such a process.

The stamping device (40) comprises means of selection of one of the programs received, the so-called base program, a unit for activating locking (45) of the stamping clock (2) onto the encoding clock used for the base program and a system of time stamping (46), by means of the stamping clock, of all the packets of at least one of the programs received which is distinct from the base program. For at least some of the packets comprising encoding clock references, the so-called time utilized packets, the time stamps are equal to these clock references. For each of the other packets, the so-called current packet, the time stamp is obtained from the clock reference of the upstream time utilized packet closest to the current packet, and from a time increment given by the stamping clock between receptions of the upstream packet and of the current packet.

The present invention concerns a device and a process for the time stamping in real time of programs of digital data streams received. It also relates to a receiver and to an assembly for delayed broadcasting comprising such a device and to a string of digital data packets associated with several programs and intermingled, which is obtained with such a process.

In digital equipment incorporating a hard disk (HDD, standing for Hard Disk Drive) and a link to a broadcasting path such as the interface of an isochronous bus or a connection to a local decoder, it is generally useful, or even necessary, to guarantee that digital data streams recorded on the hard disk will thereafter be read and broadcast via the link, while complying with the predetermined temporal behaviour constraints. In particular, when the data stream is coded according to an MPEG standard by an encoder and is received by a decoder so as to be broadcast, the standard requires compliance with a clock frequency of 27 MHz +/−30 ppm (cf. the ISO/IEC standard 13818-1 , § 2.4.2.1) on reception. The system reference clock of the decoder (hereinafter the “decoder clock”) is then latched onto the system reference clock of the encoder (hereafter the “encoder clock”), by means of clock references or PCRs (standing for Program Clock References) giving time information incorporated into the data stream (cf. in particular Table 2-6 of the ISO/IEC standard 13818-1, giving the adaptation field for a transport train or TS-standing for Transport Stream). Noncompliance with the frequency constraints is manifested as jumps or repetitions due respectively to buffer memory overflows or underfills.

Now, once the stream has been recorded on the disk, nothing can ensure that this temporal coherence is complied with when the recorded stream is read, unless a particular means adapted for this purpose has been designed. Specifically, the data string is extracted at a disk reading speed. Recording on disk therefore wrecks the initial temporal behaviour.

This temporal incoherence is unacceptable when the recorded data have to be sent to an MPEG decoder via an isochronous bus, such as a bus of the IEEE 1394 type or a USB bus in isochronous mode. Specifically, the transport train would have to conform to the MPEG standard in order for the decoder clock downstream of the bus to have an implementation frequency adapted to the encoder clock, since this decoder behaves as if it received the data stream directly from the encoder. Moreover, an isochronous bus such as the IEEE 1394 bus must be used in “push” mode: the data are transmitted at the rate they are received, by virtue of a stamping mechanism conforming to the standard for this bus. It is not therefore possible to provide feedback control of the speed of broadcasting of bits.

When the recorded data are sent to a local MPEG decoder so as to be broadcast directly to a user, the break in rate is not critical since the frequency of transfer is governed by this decoder. Transmission of the data is then performed in “pull” mode: the decoder extracts the useful information from the disk in due course, by means of adapted mechanisms which can include in particular direct memory access systems or DMAs and FIFOs memories. Thus, the DMAs may require data stored on the hard disk as a function of the level of fill of a bit buffer memory. Although the decoder clock does not need to be latched onto the encoder clock, its value must be fixed in a span allowing television sets to recover:

an acceptable line frequency (tolerance of +/−100 ppm according to the ITU-R BT0.472-3 standard) and

an acceptable chrominance subcarrier (tolerance of around +/−80 to 100 ppm according to the manufacturers specifications).

The temporal incoherence resulting from the recording on disk therefore runs the risk of being penalizing, even if it is not crippling.

To make it possible to reconstruct correct temporal functioning during the reading of a data string stored on a disk, it has been proposed that time stamps be inserted into packets of transport trains before recording them. These time stamps are determined by the values of a local write time counter on the arrival of each packet in the recording system. During reading, these values recorded on the disk are compared with those of a local read time counter, and the packets are broadcast (via a memory) only when this read counter reaches the corresponding recorded values.

A drawback of this technique is that it requires a top-of-the-range clock controlling the write and read time counters, so as not to introduce additional errors in frequency accuracy. Specifically, the stream received meets the necessary time requirements, for example a frequency of 27 MHz +/−30 ppm for MPEG transport trains. The writing, followed by the reading, of the recorded data therefore widen the margin of error beyond acceptable limits. Consequently, just one clock having both very high accuracy and very low drift (for example +/−1 ppm) may validly be used, but such a clock is expensive. Moreover, even in this case, it is difficult to guarantee sufficient stability over a number of years.

Another drawback is that in order to make it possible to watch a program and to simultaneously make a recording on disk or read from the disk, two clocks are required: a first, such as a controlled oscillator or VCXO (Voltage Controlled Crystal Oscillator), latched to the program being broadcast and a second (of high accuracy) for the recorded programs.

International Patent Application WO-98/40889 describes the recording of several programs included in an MPEG transport train on a recording medium. One of the programs received is used to latch an oscillator operating at an average frequency of 27 MHz onto the encoding clock associated with this program, by means of the PCRs associated with this program. All the packets thus used are assigned time stamps equal to the PCRs of which they are carriers, while the intermediate packets are stamped with counter values given by the slaved oscillator.

The method described in this document makes it possible to eliminate in essence, the frequency errors introduced by the MPEG source before recording and also those introduced during writing to disk, since by virtue of the locking of the oscillator onto the encoding clock, both types of errors are compensated for. The remaining errors, of a lower order, are those originating from clock inaccuracies between the PCRs used consecutively for the locking. Thus, to within this inaccuracy, the frequency error is given entirely by the read clock. In order that the stream produced during reading on the recording medium should comply with the time requirements, it is therefore sufficient to choose an oscillator having the targeted accuracy, that is to say 27 MHz +/−30 ppm, for this read clock.

The field of application of this known technique nevertheless proves to be restricted. Firstly, if the various programs of the transport train are not latched onto the same time base, only the program serving to latch the local oscillator is stamped correctly. The other programs are assigned time stamps having no relation with their own encoding clocks, so that the errors in the source frequency and write frequency are not compensated for, but might possibly be compounded. Thus, if the source clock, write to disk clock and read from the disk clock each comply with the MPEG standard (error of +/−30 ppm in 27 MHz), the aggregate error is in a span of +/90 ppm, this being unacceptable.

Moreover, such a system does not permit the real time broadcasting of a program and the simultaneous recording on disk of one or more other programs, whether the latter are Included in the same transport train as the former or in a separate transport train. Specifically, the local clock is then latched onto the encoding clock for the program being watched, which does not generally correspond to the encoding clocks for the programs to be recorded.

The use of two oscillators, the one locked onto the encoding clock for the program broadcast in real time and the other onto the encoding clock for one of the recorded programs, makes it possible to overcome this difficulty at the cost of an increase in the complexity of the device. However, it does not solve the problems posed by the simultaneous recording of programs not sharing the same reference clock.

The present invention relates to a time stamping device, making it possible to record several programs simultaneously on a recording medium while complying with the temporal broadcasting constraints during the reading of the recorded programs, whether or not these programs have synchronized reference clocks.

The stamping device of the invention also makes it possible to broadcast a program in real time and simultaneously to record on a recording medium or to read from this medium one or more other programs, while complying with the temporal broadcasting constraints during the reading of the recorded programs, even if these recorded programs do not have reference clocks corresponding to that of real time broadcasting.

The invention also relates to a receiver and to a broadcasting assembly comprising such a device, as well as to a stamping process having the advantages cited above and to a string of packets of digital data obtained by means of the stamping device or process of the invention.

The invention has applications in all sorts of digital equipment, such as for example digital televisions, receivers with built-in MPEG decoders, also referred to as IRDs (Integrated Receivers Decoders) or set-top boxes, and DVD players. It is especially beneficial in respect of transfers of signals of transport trains from a hard disk to an IEEE 1394 bus.

Accordingly, the subject of the invention is a device for the time stamping in real time by means of a stamping clock of one or more programs of one or more simultaneous streams of digital data received. These streams comprise packets able to be associated with at least two programs, each of the packets comprising a header containing an indicator identifying the program associated with the said packet and at least some of the packets, the so-called time referenced packets, also comprising clock references. The clock references give times measured by means of encoding clocks used respectively for the programs associated with the corresponding packets. The stamping device also comprises:

a module for reading the indicators identifying the programs in each of the packets,

means for selecting one of the programs, the so-called base program.

a module for reading the clock references of at least some of the time referenced packets of the base program, the so-called time utilized packets of the base program,

a unit for activating locking of the stamping clock to the encoding clock used for the base program, the so-called base clock, by means of the clock references of the base program which are read by the module for reading the clock references,

and a system of time stamping, by means of the stamping clock, of all the packets of at least one of the programs, the so-called program to be stamped, upon reception of the said packets, the programs to be stamped possibly including at least one program distinct from the base program.

According to the invention:

the module for reading the clock references is designed also to read the clock references of at least some of the time referenced packets associated with the programs to be stamped which are distinct from the base program, the so-called time utilized packets of the said programs,

and the time stamping system is designed to assign for each of the programs to be stamped:

to each of the time utilized packets of the said program, a time stamp equal to the clock reference of the said packet.

and to each of the packets, the so-called current packet, of the said program received between two successive time utilized packets the so-called upstream packet and downstream packet, respectively, a time stamp obtained from at least the clock reference of the upstream packet and of a time increment given by the stamping clock between receptions of the upstream packet and of the current packet.

The various entities defined in respect of the stamping device (reading modules, means of selection, locking unit, time stamping system) should be understood according to a functional rather than a physical meaning. They may for example be grouped together as parts within a single component or within a single piece of software.

By contrast with the prior document WO-98/40889, the stamping device of the invention does not merely take account of the clock references of just one of the programs (the base program), but is capable of taking into consideration the encoding clocks for all the programs to be stamped. More precisely, although the stamping clock is latched onto the base clock, it is possible, surprisingly, to obtain the desired time accuracy with regard to all the broadcastings of recorded programs. whether or not their encoding clocks are synchronized with the base clock.

This favourable behaviour is explained in theory as follows. The following notation is used for a given program to be stamped, which is recorded after stamping and is then subsequently read so as to be broadcast:

F_{O} the reference frequency (27 MHz for the MPEG standard);

F_{T} (“T” for “target”) the frequency to be obtained during reception of the program (for example the frequency regenerated in a target MPEG decoder), and ΔT the relative difference between F_{T} and F_{O}: F_{T}=F_{O}.(1+ΔT) (according to the MPEG standard, we must therefore have: −30 ppm≦ΔT≦30 ppm);

F_{S} (“S” for “source”) the frequency of reception of the stream of the program before stamping and ΔS the relative difference between Fₛ and F_{O}:F_{S}=F_{O}.(1+ΔS);

F_{W} (“W” for “write”) the frequency of the stamping clock and ΔW the relative difference between F_{W} and F_{O}: F_{W}=F_{O}.(1+ΔW);

and F_{R} (“R” for “read”) the frequency of the clock used to read the recorded program, the so-called “read clock” and ΔR the relative difference between F_{R} and F_{O}: F_{R}=F_{O}.(1+ΔR).

The frequency of FT is given by:

F_{T}=F_{S}+F_{R}−F_{W}=F_{O}. (1+ΔS+ΔR−ΔW)

Now, the packets of the program are stamped either exactly for the time utilized packets (in this case, the time stamps are identical to the clock references), or approximately for the intermediate packets (by means of the stamping clock). A sufficient number of time utilized packets are chosen from among the time referenced packets so that the overall time accuracy of broadcasting of the program after reading is only negligibly affected thereby. We therefore have, to within a negligible error:

ΔW=ΔS

and consequently:

F_{T}=F_{O}.(1+ΔR)

The frequency regenerated on reading the recorded program is therefore substantially equal to that of the read clock. Consequently, it suffices for this read clock to meet the time accuracy specifications with regard to the reception of the stream (+/−30 ppm for the MPEG standard) in order to guarantee the compliance of the stream received. In fact, in this way, indirectly, a locking of the stamping clock is achieved at once onto all the encoding clocks.

Another advantage of the invention is that a single clock is required ill order to perform simultaneously and with the desired accuracy in the time stamps, the stamping of several programs and the real time broadcasting of another program. This advantage is especially beneficial in respect of MPEG decoders, since most of the MPEG integrated circuits are furnished with one clock only.

What is more, although the addition of a second clock in an MPEG decoder would make it possible simultaneously to perform a real time broadcasting of one program and the recording of another (or of several others referenced with one and the same encoding clock), with sufficiently accurate time stamps, the invention is advantageous relative to a potential setup such as this. Specifically, it also makes it possible to record several programs from one and the same transport train, which are referenced by distinct encoding clocks.

Thus, the invention is advantageously used to record a complete transport train.

According to an advantageous mode of selection of the time utilized packets of a program to be stamped, all the time referenced packets are time utilized. This mode of selection gives optimal accuracy. According to another advantageous mode of selection of the time utilized packets, a minimum number of intermediate packets or a minimum duration between two time utilized packets is fixed. This other mode of selection has the advantage of rendering the stamping faster, at the cost of a loss of accuracy.

The stamped programs are preferably intended to be recorded on a recording medium such as advantageously a hard disk, then to be read subsequently. In one advantageous form of utilization of the stamped programs, the latter are written directly to the recording medium, preferably as and when they are stamped. In another form of utilization, they are broadcast to external recording systems, in particular by means of a communication line or a network.

In a first form of installation, the stamping device is embodied by a software path. In this case, an interrupt is advantageously sent to the central unit upon each arrival of a packet. In a second form of embodiment, this device is supported by a dedicated hardware facility.

In a first preferred form of determination of the time stamps, the time stamping system is designed to assign to each of the current packets a time stamp equal to the sum of the clock reference of the upstream packet and of the time increment. This form of determination is especially simple and makes it possible to obtain good accuracy, in so far as the time utilized packets are sufficiently close together. The jitter present in respectively intermediate packets is then negligible.

Denoting by PCR_Rᵢ the clock reference of a time utilized packet i of a program to be recorded, and C(t) the value of a local counter synchronized by the stamping clock at time t, the time stamp therefore equals:

PCR_Rᵢ for the time utilized packet i which arrived at tᵢ,

PCR_Rᵢ+(C(t)−C(tᵢ)), for the packets of the same program which arrived at time t and lie between the time utilized packet i and the next time utilized packet of the program.

In particular, for packets of transport trains of an MPEG stream, the MPEG standard imposes a maximum duration of 100 ms between two consecutive time referenced packets. Thus, in the advantageous case where all the time referenced packets are time utilized, the buffer memory drift in a target decoder does not exceed 45 bytes (that is to say less than one transport train packet). This maximums drift is in fact given by:

27 MHz×100 ms×(2×30 ppm)×(60 Mbit/s/8)/27 MHz.

Consequently, the impact of the jitter on the buffer memory of the target decoder is very weak.

Advantageously, the sum of the clock reference of the upstream packet and of the time increment is calculated in the following manner, by means of a local counter synchronized by the stamping clock. With each arrival of a time utilized packet of a program, the difference Δᵢ between the clock reference PCR_Rᵢ of the packet and the value C(tᵢ) of the local counter upon its arrival (at time tᵢ) is calculated and stored. It is the sum (Δᵢ+C(t)) of the difference Δᵢ and of the value C(t) of the local counter upon the arrival of each new packet of the program which is then used to determine the time stamps, until the arrival of the next time utilized packet of this program.

In a second preferred form of determination of the time stamps, the time stamping system is designed to assign to each of the said current packets a time stamp equal to the product of the time increment and of the quotient of the difference between the clock references of the downstream and upstream packets by the difference between the times of reception of the downstream and upstream packets.

Denoting by PCR_Rᵢ and PCR_Rᵢ₊₁ the clock references of two consecutive time utilized packets i and (i+1) of a program to be recorded, the time stamp therefore equals:

PCR_Rᵢ for the time utilized packet i which arrived at tᵢ,

PCR_Rᵢ₊₁ for the time utilized packet (i+1) which arrived at tᵢ₊₁,

((C(t)−C(tᵢ))×(PCR_Rᵢ₊₁−PCR_Rᵢ)/(C(tᵢ₊₁)×C(tᵢ))), for the packets which arrived at time t and lie between the time utilized packets i and (i+1) of the same program.

This form of determination therefore relies on a linear interpolation of the times between two successively utilized clock references. It makes it possible to improve the accuracy of the time functioning and to reduce the buffer memory drift, in exchange for additional calculations.

The base program is either itself subjected to stamping, or not.

Thus, in an advantageous mode of determination of the base program, the means of selection of this base program are designed to select from among the programs of the streams received, a program decoded in real time. The expression “program decoded in real time” is understood to mean a program decoded at the same time as the implementation of the time stamping. This program can in particular be:

broadcast directly to a user (program followed locally by this user);

broadcast with shifted reading to a user (time shift); in this case, this program is preferably subjected to the time stamping before recording;

or sent to another system after decoding.

The decoded program is for example processed by a decoder coupled to the stamping device and using the same clock. Thus, the local clock of the decoder can be used conventionally for the broadcasting of the program to the screen, while also acting as stamping clock.

More precisely, the means of selection of the base program are preferably such:

that they comprise an indicator of reception of a program decoded in real time in the streams received

and that they are designed to select, from among the programs of the streams received, one of the programs to be stamped when the indicator of reception indicates an absence of reception.

This embodiment thus takes into account, by switching from one mode of selection to another of the base program, the two possible situations of reception and non-reception of a program to be decoded in real time. In this way the system operates even when the stamping clock cannot be latched onto such a program.

The selecting of the base program from among the programs to be stamped can consequently be enabled either in the absence of reception of a program to be decoded in real time (in the above mode of embodiment), or systematically (the base program then always forms part of the programs not decoded in real time and to be stamped).

Various techniques making it possible to select one program from among programs to be stamped will be found in particular described in the document WO-98/40889.

Advantageously, the means of selection of the base program are designed to select, from among the programs to be stamped, the first of these programs for which a clock reference is detected.

Moreover, the means of selection of the base program are advantageously such:

that they comprise means of determination of the end of the current base program, such as for example a timer, capable of measuring the duration elapsed since the reception of the last time utilized packet of the current base program,

and that they are designed to select as base program one of the programs to be stamped and to switch the selection of the current base program to another of the programs when these means of determination detect the end of the current base program, for example when this measured elapsed duration is greater than a predetermined maximum duration.

The new base program is then preferably determined according to a common criterion, for example a first for which a clock reference is detected.

Advantageously, the time stamping device is capable of undertaking, a tone stamping of digital data coded according to an MPEG standard, these streams preferably comprising transport trains.

The invention also pertains to a receiver of one or more simultaneous streams of digital data.

This receiver is characterized in that it comprises a time stamping device in accordance with the invention.

In an advantageous form of embodiment of the receiver, the latter comprises a device for recording, on a recording medium, at least one of the programs stamped by means of the time stamping device. The time stamps are then used subsequently to read while complying with an appropriate time functioning the programs stored on the medium.

In another form of embodiment, the receiver does not comprise such a recording device, but is designed to send the stamped programs to an external system where they will be recorded. For example, the receiver consists of a server transmitting to a multitude of sets which are furnished with hard disks and with appropriate means of reading the time stamps.

In the advantageous embodiment in which the receiver comprises a recording device, the recorded programs requiring in read mode a predetermined clock frequency and a predetermined accuracy with regard to the said frequency, the said receiver preferably comprises a device for reading the said recorded programs, which device is associated with a read clock. The reading device is then capable of producing the predetermined frequency with the predetermined accuracy by means of the read clock. Specifically, in accordance with what has been set forth above, one thus succeeds in obtaining the desired accuracy for the streams received by target receivers.

According to a first form of obtaining the desired accuracy with regard to the read clock, the latter has itself features offering this accuracy. For example, for MPEC streams, it may be a VCXO whose frequency of 27 MHz with an error margin of +/−30 ppm is guaranteed for a nominal voltage, being determined by measurements during manufacture.

According to a second form of obtaining the desired accuracy with regard to the read clock, the reading device comprises an indicator of locking of the read clock onto clock references of a program received during reading, this program being received at the predetermined frequency with the predetermined accuracy. For example, the read clock is latched onto a program meeting the MPEG standard (hence having an encoding clock at 27 MHz +/−30 ppm), at the time of reception and of reading of this program.

According to a third form of obtaining the desired accuracy with regard to the read clock, the latter consists of the stamping clock and the reading device comprises a control memory designed to store for the recorded programs an average value of frequency correction for the said programs with respective to the stamping clock. The stamping device is then designed to record this average value in the control memory and the reading device is designed to use this average value to control the read clock.

When the second form of obtaining is used, it is preferably coupled to the third, the reading being performed by means of the second form when an appropriate program is received and read, and by means of the third form otherwise.

The subject of the invention is also an assembly for delayed broadcasting comprising at least one receiver in accordance with the invention fitted with recording and reading devices.

This broadcasting assembly is characterized in that it also comprises one or more recording media designed to be used by the recording devices of the receivers, and one or more links of the reading devices respectively to one or more broadcasting paths for the programs recorded on the recording media.

The links then advantageously comprise:

at least one connection to an isochronous bus, preferably chosen from among a bus of the IEEE 1394 type and an isochronous mode USB bus;

and/or at least one connection to a local decoder.

As set forth above, the connection to an isochronous bus renders the stamping device of the invention especially beneficial, since the latter makes it possible to fully utilize the capacity of temporal reconstruction of the streams.

The invention also applies to a process for the time stamping in real time by means of a stamping clock of at least one program of at least one simultaneous stream of digital data received. These streams comprise packets associated with at least two programs, each of the packets comprising a header containing an indicator identifying the program associated with the said packet. Moreover, at least some of the packets, the so-called time referenced packets, also comprise clock references giving times measured by means of encoding clocks used respectively for the programs associated with these packets. The process comprises the steps of:

reading of the indicators identifying the programs in each of the packets.

selection of one of the said programs, the so-called base program,

reading of the clock references of at least some of the time referenced packets of the base program, the so-called time utilized packets of the base program,

locking of the stamping clock to the encoding clock used for the base program, the so-called base clock, by means of the clock references of the base program which are read by the module for reading the clock references.

and time stamping, by means of the stamping clock, of all the packets of at least one of the programs, the so-called program to be stamped, upon reception of the said packets, the programs to be stamped including at least one program distinct from the base program (but which may also include the base program).

According to the invention:

the clock references of at least some of the time referenced packets associated with the programs to be stamped which are distinct from the base program, the so-called time utilized packets of the said programs, are also read and

during the time stamping, there are assigned for each of the said programs to be stamped:

to each of the time utilized packets of the said program, a time stamp equal to the clock reference of the said packet,

and to each of the packets, the so-called current packet, of the said program received between two successive time utilized packets the so-called upstream packet and downstream packet, respectively, a time stamp obtained from at least the clock reference of the upstream packet and of a time increment given by the stamping clock between receptions of the upstream packet and of the current packet.

The invention also pertains to a string of digital data packets associated with at least two programs. The packets associated with the said programs are intermingled and comprise respectively time stamps. Moreover, some at least of the packets of each of the said programs, the so-called time referenced packets, also comprise clock references which give times measured by means of encoding clocks used respectively for the programs associated with the said packets.

According to the invention, the time stamps of at least some of the time referenced packets of each of the programs are identical to the clock references of the said packets.

Such a string may be obtained by means of the device or of the process for time stamping of the invention, it is or is not stored on a recording medium. By contrast with a string which would be obtained by the device described in document WO-98/40889, several programs benefit from the coincidence between the time stamps and the clock references of some of the packets. In the prior document, on the contrary, only one of the programs (that chosen to latch the stamping clock) has this property. Thus, the string of the invention, while permitting shuffling of the packets of several programs, allows reading with accurate time reconstruction for all these programs, and not just for one of them.

The invention will be better understood and illustrated by means of the following wholly nonlimiting exemplary embodiments and implementations, with reference to the appended figures in which:

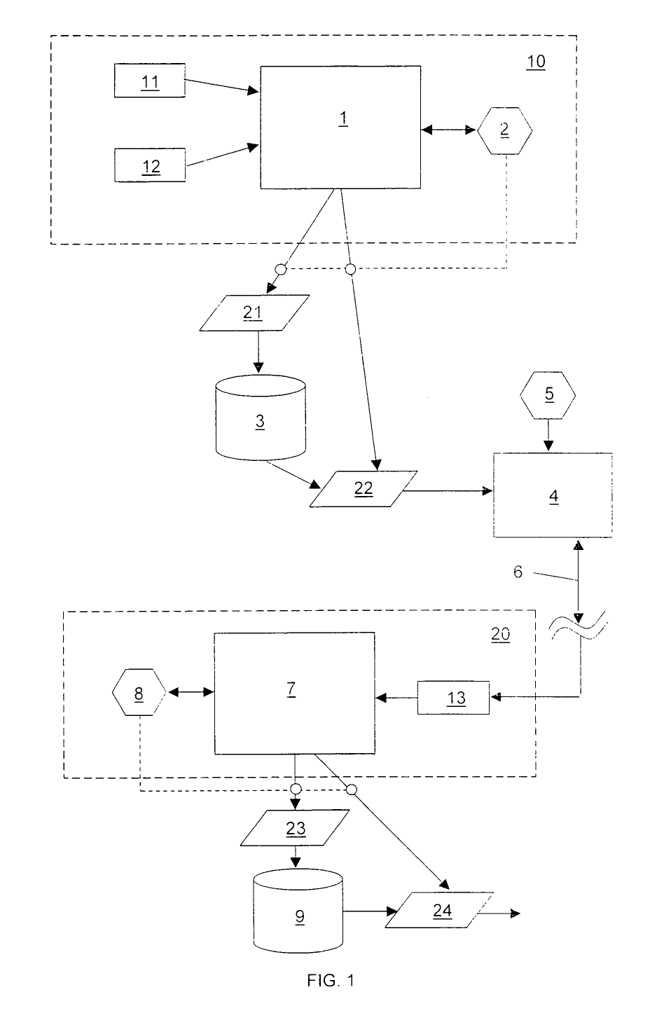

FIG. 1 shows a first system architecture, comprising two IRDs receivers fitted with stamping devices according to the invention and equipped with hard disks, linked by an IEEE 1394 bus;

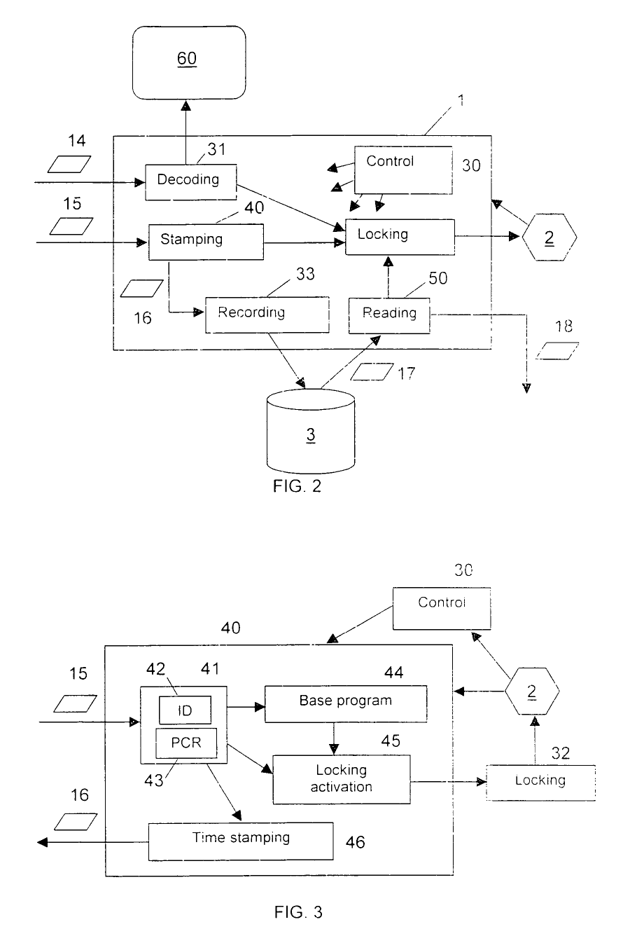

FIG. 2 diagrammatically represents a central system and a local clock of the IRD upstream of the bus, with its hard disk, the central system comprising in particular devices for recording, for time stamping and for reading;

FIG. 3 diagrammatically shows the time stamping device of the IRD of FIG. 2, and its relations with the local clock of this IRD;

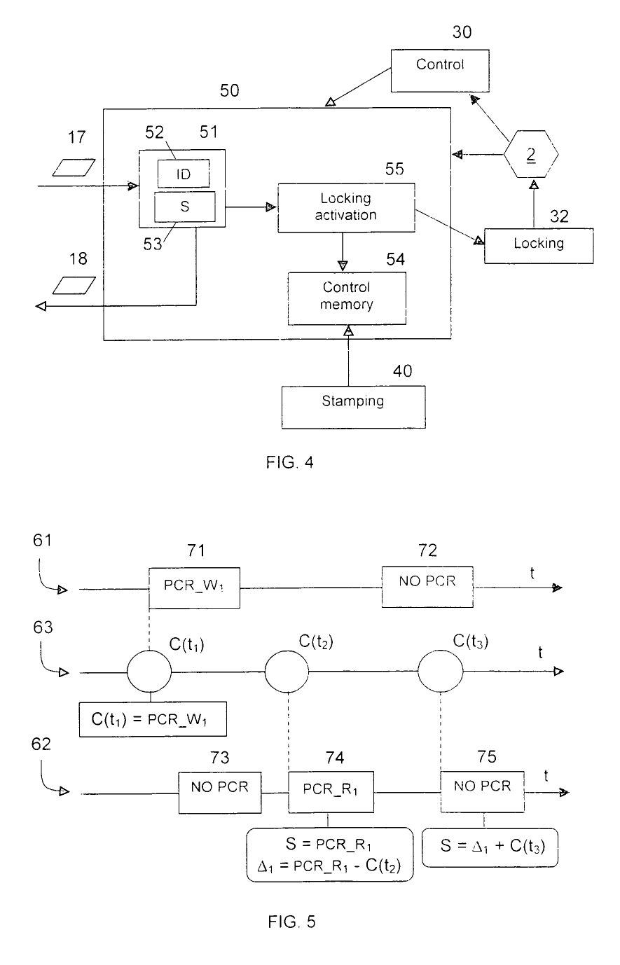

FIG. 4 diagrammatically shows the reading device of the IRD of FIG. 2, and its relations with the local clock of this IRD;

FIG. 5 illustrates a first technique of assigning time stamps to a program to be recorded, by means of a local counter latched onto a program being watched, in accordance with the time stamping process of the invention:

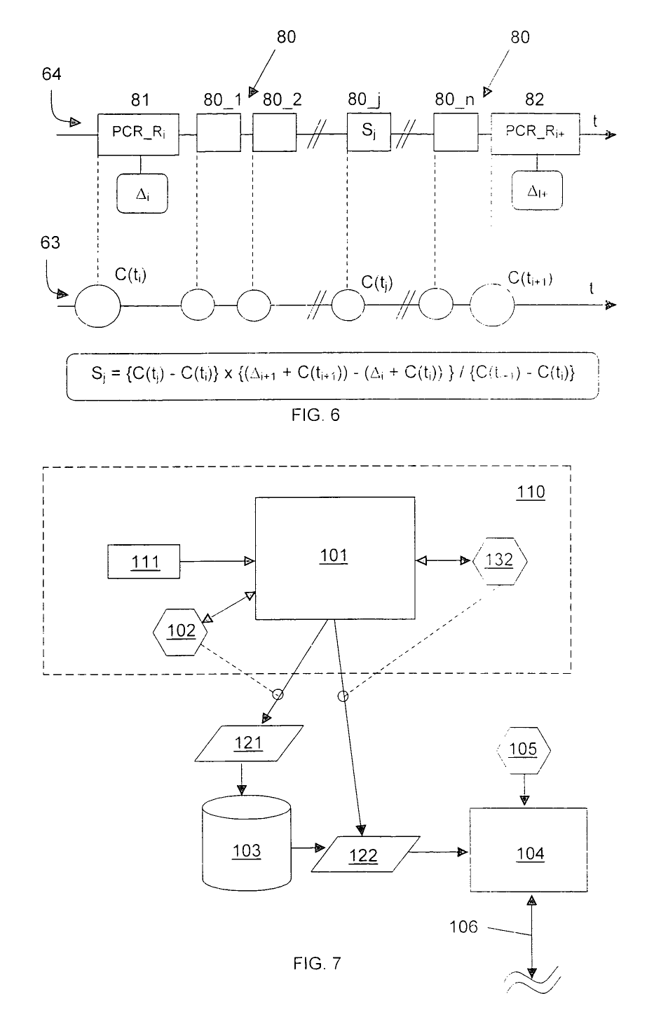

FIG. 6 illustrates a second technique of assigning time stamps to a program to be recorded, by means of a local counter latched onto a program being watched, in accordance with the time stamping process of the invention;

FIG. 7 shows a second system architecture, comprising an IRD receiver fitted with a stamping device according to the invention and equipped with a hard disk, linked to an IEEE 1394 bus.

A first system architecture (FIG. 1) comprises a first IRD 10 linked to a second IRD 20 by an IEEE 1394 bus referenced 6, via an interface 4 comprising a link layer (LINK) and a physical layer (PHY) and fitted with a bus clock 5. The clock 5 makes it possible to assign specific time stamps to the packets travelling through the bus 6. The IRDs 10 and 20 are respectively associated with hard disks 3 and 9, provided for storing in particular recorded programs.

The IRD 10 comprises a central system 1, comprising a central unit and a decoder, a local clock 2 and two input stages (front ends) 11 and 12, capable respectively of receiving in parallel two streams TS. The local clock 2 is for example a VCXO having a frequency accuracy below that required for the MPEG standard (frequency of 27 MHz +/−30 ppm), intended to be latched onto a clock having the desired accuracy. The input stages 11 and 12 are designed to receive streams intended respectively to be broadcast live and recorded. The central system 1 comprises means:

for decoding these streams,

for real time broadcasting of programs of the stream originating from the input stage 11,

for stamping programs selected from the stream originating from the input stage 12, by means of time stamps 21, and for recording these programs on the disk 3,

and for reading programs recorded on the disk 3 implementing a utilization of time stamps 22.

The IRD 20 comprises a central system 7, comprising a central unit and a decoder, and a local clock 8, for example of the same type as the local clock 2, as well as an input stage 13 designed to receive a TS stream. The central system 7 comprises means:

for decoding this stream,

for real time broadcasting of the programs of this stream.

for stamping programs of this stream (which are or are not identical to the previous ones) by means of time stamps 23, and for recording these programs on the disk 9,

and for reading programs recorded on the disk 9, implementing a utilization of time stamps 24.

The central system 1 of the IRD 10 will now be detailed with reference to FIGS. 2 to 4. The central system 7 of the IRD 20 is similar, to within elementary adaptations, and will therefore not form the subject of such a description. The main difference is that, the IRD 20 having just one input stage, a stream received can contain both a program to be broadcast in real time and programs to be recorded. The IRD 20 therefore comprises means for switching from live-broadcasting functionalities to recording functionalities, according to the programs to which the packets received belong.

The central system 1 essentially comprises (FIG. 2):

an MPEG decoder referenced 31, receiving packets 14 of transport trains originating from the input stage 11 and decoding them, in such a way as to produce decoded images broadcast on a screen 60.

a time stamping device 40, affixing time stamps to packets 15 originating from the input stage 12, producing stamped packets 16.

a device 32 for locking the local clock 2, which is linked to the decoder 31 and to the time stamping device 40,

a recording device 33, recording the stamped packets 16 in the disk 3,

a reading device 50, reading the information contained in the disk 3, in particular in the form of time stamped packets 17, and broadcasting packets 18 corresponding to the packets 17, at a temporal rate determined by the time stamps of the packets 17,

and a control unit 30, controlling the various elements of the central system 1 and linked to the local clock 2.

The time stamping device 40 (FIG. 3) comprises:

a reading unit 41, designed to read the indicators ID identifying the programs (module 42) and any clock references PCR (module 43), in the headers of the packets 15 received,

a unit 44 for selecting a base program intended to be used to latch the local clock 2, and linked to the reading unit 42,

a locking activation unit 45, linked to the reading unit 41 and selection unit 44, capable of activating the locking device 32 and sending it information relating to the packets of the base program,

and a time stamping system 46 linked to the reading unit 41, producing the stamped packets 16 by adding time stamps S to the headers of the packets 15.

The reading device 50 comprises (FIG. 4):

a reading unit 51, designed to read the indicators ID identifying the programs (module 52) and the time stamps S (module 53) in the headers of the packets 17 read from the disk 3, and broadcast the packets 18 as a function of the values of the time stamps S,

a control memory 54 linked to the time stamping device 40, designed to store an average value of frequency correction with respect to the local clock 2 for the programs recorded on the disk 3,

and a locking activation unit 55, linked to the reading unit 51 and to the control memory 54, capable of activating the locking device 32 and of sending it information relating to the correction values for the program read.

In what follows, the streams received by the IRD 10 are regarded as TS streams meeting the MPEG standard in particular in respect of the time constraints.

During operation, when a TS stream reaches the input stage 11, a program of this stream is decoded by means of the decoder 31 and it is broadcast on the screen 60. To obtain appropriate time functioning, the local clock 2 is for this purpose latched onto the clock references of the decoded program.

When a TS stream reaches the input stage 12, one or more programs of this stream being intended to be recorded on the disk 3, a base program is selected which must be used to latch the local clock 2, by means of the selection unit 44. If a program is currently being broadcast to the screen 60, the base program selected is the one decoded. The locking activation unit 45 is then not invoked. On the other hand, if no program is currently being broadcast, the base program is determined from among the programs to be recorded, and then the locking activation unit 41 is enabled so that it latches the local clock 2 onto the base program, via the locking device 32.

The criterion for selecting the base program from among the programs to be recorded is for example a criterion of first detection of a clock reference: as soon as the reading module 43 detects the presence of a PCR in one of the packets received of one of the programs to be recorded, the corresponding program (identified by the reading module 42) is chosen as base program.

Several types of switchings of the base program may occur in the course of recording. These switchings are controlled by means of the control unit 30. Thus:

when the base program consists of one of the programs to be recorded and when the decoding of a program commences so as Lo broadcast it to the screen 60, the latter is automatically adopted for locking the base clock 2;

when the base program consists of a program currently being decoded and when this program ceases, the selecting of the base program from among the programs to be recorded is enabled;

when the base program selected from among the programs to be recorded is completed, while the other programs to be recorded continue to be received in the incoming TS stream, the procedure for selecting the base program from among the programs remaining to be recorded is re-enabled.

An improvement in the switching for the base program from one program to be recorded to another, relies on a re-enabling of the selection when the quantity of information supplied by the base program for stamping the packets is insufficient. This circumstance occurs either because the base program has terminated, or because the packets of this program which are utilized for stamping (referred to as the time utilized packets) are too far apart. For this it is for example possible to use a timer measuring the duration elapsed since the last time utilized packet and a predetermined maximum duration. When the duration elapsed exceeds the maximum value without a new time utilized packet being identified, switching is triggered.

The packets 15 received are then stamped by means of the stamping system 46, with reference both to the local clock 2 latched onto the base program, to the indicator ID identifying the program concerned and to the clock references of this program. In the examples described, all the clock references of the programs to be recorded are utilized for the stamping, but in variant implementations, only some of these references are taken into account (for example every second reference).

In a first example of time stamping, each packet of a program to be recorded is assigned the sum of the last PCR of this program and of the duration elapsed since, measured by means of the local clock 2, itself latched onto the base program.

As represented by way of illustration in FIG. 5, the base program consists of a program 61 broadcasting in real time, which comprises packets 71 with PCRs (denoted PCR_Wᵢ, with “W” standing for “watch”) and packets 72 without PCRs. A program 62 to be recorded also comprises packets 74 with PCRs (denoted PCR_Rᵢ, with “R” standing for “record”) and other packets 73, 75 without PCRs. The clock 2 is latched onto the clock references PCR_Wᵢ of the program 61 and a local counter giving values C(t) as a function of time t (axis 63) synchronized to the clock 2 is used. Thus, when the system is stable, the value C(t₁) at the instant to of arrival of the packet 71 of the program 61 broadcast equals PCR_W₁.

At the instant t₂ of arrival of the first packet 74 with clock<reference PCP_R₁ of the program 62 to be recorded, the counter equalling C(t₂):

the packet 74 is assigned a time stamp S equal to this clock reference PCR_R₁,

and the discrepancy Δ₁ between this clock reference PCR_R₁ and the value C(t₂) of the counter is calculated and stored:

Δ₁=PCR_{—}R₁−C(t₂)

Then, at the instant t₃ of arrival of the packet 75 following the packet 74 and devoid of clock reference, the counter equalling C(t₃), the packet 75 is assigned a time stamp S equal to the sum of the discrepancy Δ₁ and of the value C(t₃) of the counter:

S=Δ₁+C(t₃)

For the succeeding packets of the program 62 we proceed as for the packet 75, until the next packet of the program 62 furnished with a clock reference. The operations performed for the packet 74 are then repeated.

In a second example of time stamping, each current packet of a program to be recorded is assigned a stamp obtained by linear interpolation of the consecutive PCRs of packets of this program flanking the current packet. This interpolation is performed with respect to the portion of duration elapsed between the upstream packet with PCR and the current packet (as measured by means of the local clock 2, itself latched onto the base program).

Thus, as represented by way of illustration in FIG. 6, a program to be recorded 64 comprises packets 81, 82 with clock references and packets 80 (80_1, 80_2 . . . 80_n) without clock references. As in the first example (FIG. 5), the local clock 2 to which a local counter is synchronized is latched onto the PCRs of the base program, possibly consisting of the program decoded in real time. The local counter has values C(tᵢ) and C(tᵢ₊₁) respectively upon the arrival of two packets, 81 so-called “upstream” and 82 so-called “downstream”, comprising consecutive clock references (denoted PCR_Rᵢ and PCR_Rᵢ₊₁).

Upon the arrival of the upstream packet 81, the value C(tᵢ) of the counter and the clock reference PCR_Rᵢ are stored, and this packet is assigned a time stamp equal to PCR_Rᵢ. Then, for the successive intermediate packets 80_{—j} the values C(tᵢⱼ) of the counter are respectively stored. We proceed with the downstream packet 82 as for the upstream packet 81. The factor K given by:

K=(PCR_{—}Rᵢ₊₁−PCR_{—}Rᵢ)/(C(tᵢ₊₁)−C(tᵢ))

is thereafter calculated and stored, and then the time stamps Sj of each of the intermediate packets 80_{—j} are determined by the formula:

Sⱼ=Kx(C(tⱼ)−C(tᵢ))

and these stamps are assigned to the corresponding packets.

The stamped packets 16 are thereafter recorded on the disk 3 by means of the recording device 33.

Moreover, an average value of frequency correction for each of the recorded programs, with respect to the local clock 2, is stored in the control memory 54 of the reading device 50.

During the reading of a program recorded on the disk 3 with a view to broadcasting it to the IRD 20 via the bus 6, the packets of the program to be transmitted are identified by means of the reading module 52. The transmission of the packets 18 obtained is paced as a function of the time stamps S which are read by means of the reading module 53 and are compared with a time counter synchronized with the local clock 2.

The locking of the local clock 2 is undertaken as follows. In the case where a program is received in parallel with the reading of the program to be transmitted or where its PCRs are used to latch the clock 2, no particular measure need be taken. In the converse case, the average value stored in the control memory 54 is used to control the clock 2, by means of the locking activation unit 55. The control unit 30 makes it possible to ensure the switching from one mode of locking to another.

Thus, with the desired time constraints, the packets of the program read from the disk 3 are made to arrive at the IRD 20. After reception of the program thus transmitted, it is either broadcast directly to the screen, or it is recorded on the disk 9. We then proceed in a similar manner to the recording made by means of the IRD 10, just as when the programs recorded on the disk 9 are read back thereafter with the IRD 20.

A second system architecture (FIG. 7) comprises a first IRD 110 associated with a hard disk 103 and linked to an IEEE 1394 bus referenced 106, via an interface 104 furnished with a bus clock 105.

The IRD 110 comprises a central system 101, comprising a central unit and a decoder, two local clocks 102 and 132 and an input stage 111. The clock 102 is for example of the same type as the clock 2 of the first architecture, while the clock 132 supplies a frequency with the accuracy required for the MPEG standard (frequency of 27 MHz +/−30 ppm). The clock 102 is used for the real-time broadcasting or for the recording of programs on the disk 103, while the clock 132 is employed for the reading of the programs recorded on the disk 103. The central system 101 comprises means.

for decoding the streams received.

for real-time broadcasting of programs of the stream.

for stamping programs, selected from the stream received, by means of time stamps 121, and for recording these programs on the disk 103.

and for reading programs recorded on the disk 103, implementing a utilization of time stamps 122.

The IRD 110 therefore differs essentially from the IRD 10 of the first system architecture:

in that it comprises a single input stage, and appropriate means for toggling real-time broadcasting/recording functionalities.

and in that it comprises a specific clock in respect of reading from the disk 103.

Thus, when reading programs recorded on the disk 103, no clock locking is required, since the clock 132 already benefits from the desired accuracy.

1. Device for the time stamping (40) in real time by means of a stamping clock (2, 8, 102) of at least one program (62, 64) of at least one simultaneous stream of digital data received, the said streams comprising packets (14; 71, 72; 73-75; 80-83) able to be associated with at least two programs (61, 62, 64), each of the packets comprising a header containing an indicator identifying the program associated with the said packet and at least some of the packets (71; 74; 81, 82), the so-called time referenced packets, also comprising clock references (PCR_Wⱼ, PCR_Rᵢ) giving times measured by means of encoding clocks used respectively for the programs (61, 62, 64) associated with the said packets, the said stamping device (40) comprising:
a module (42) for reading the indicators (ID) identifying the programs (61, 62, 64) in each of the packets,
means (44) for selecting one of the said programs (61), the so-called base program,
a module (43) for reading the clock references (PCR_Wⱼ) of at least some of the time referenced packets (71) of the base program (61), the so-called time utilized packets of the base program,
a unit for activating locking (45) of the stamping clock (2, 8, 102) to the encoding clock used for the base program (61), the so-called base clock, by means of the clock references (PCR_Wⱼ) of the base program (61) which are read by the module (43) for reading the clock references.
and a system of time stamping (46), by means of the stamping clock (2, 8, 102), of all the packets (74, 75; 80-83) of at least one of the programs (62, 64), the so-called program to be stamped, upon reception of the said packets, the programs to be stamped (62, 64) possibly including at least one program distinct from the base program (61),
characterized in that:
the module (43) for reading the clock references is designed also to read the clock references (PCR_Rᵢ) of at least some of the time referenced packets (74, 81, 82) associated with the programs to be stamped (62, 64) which are distinct from the base program (61), the so-called time utilized packets of the said programs,
and the time stamping system (46) is designed to assign for each of the said programs to be stamped (62, 64):
to each of the time utilized packets (74, 81, 82) of the said program (62, 64), a time stamp (S) equal to the clock reference (PCR_Rᵢ) of the said packet,
and to each of the packets (75, 80, 83), the so-called current packet, of the said program (62, 64) received between two successive time utilized packets (74, 81, 82) the so-called upstream packet (74, 81) and downstream packet (82), respectively, a time stamp (S) obtained from at least the clock reference (PCR_Rᵢ) of the upstream packet (74, 81) and of a time increment (C(t)−C(tᵢ)) given by the stamping clock (2, 8, 102) between receptions of the upstream packet (74, 81) and of the current packet (75, 80, 83).

2. Time stamping device according to claim 1, characterized in that the time stamping system (46) is designed to assign to each of the said current packets (75) a time stamp equal to the sum (PCR_Rᵢ+(C(t)−C(tᵢ))) of the said clock reference (PCR_Rᵢ) of the upstream packet (74) and of the said time increment (C(t)−C(tᵢ)).

3. Time stamping device according to claim 1, characterized in that the time stamping system (46) is designed to assign to each of the said current packets (83) a time stamp equal to the product ((C(t)−C(tᵢ))×(PCR_Rᵢ₊₁₋PCR_Rᵢ)/(C(tᵢ₊₁)−C( tᵢ))) of the said time increment (C(t) −C(tᵢ)) and of the quotient of the difference (PCR_Rᵢ₊₁−PCR_Rᵢ) between the clock references of the said downstream (82) and upstream (81) packets by the difference (C(tᵢ₊₁)−C(tᵢ)) between the times of reception of the said downstream (2) and upstream (81) packets.

4. Time stamping device according to any one of the preceding claims, characterized in that the means of selection (44) of the base program (61) are designed to select from among the said programs (61, 62, 64) of the streams received, a program decoded in real time (61).

5. Time stamping device according to claim 4, characterized in that the means of selection (44) of the base program comprise an indicator of reception of a program decoded in real time (61) in the said streams received and in that the said means of selection (44) are designed to select, from among the said programs of the streams received, one of the programs to be stamped when the said indicator of reception indicates an absence of reception.

6. Time stamping device according to any one of the preceding claims, characterized in that the means of selection (44) of the base program are designed to select, from among the programs to be stamped (62, 64), the first of the said programs for which a clock reference (PCR_Rᵢ) is detected.

7. Time stamping device according to any one of the preceding claims, characterized in that the means of selection (44) of the base program comprise means of determination of the end of the current base program, and in that the said means of selection are designed to select as base program one of the programs to be stamped and to switch the selection of the current base program to another of the programs when the said means of determination detect the end of the current base program.

8. Time stamping device according to any one of the preceding claims, characterized in that it is capable of undertaking a time stamping of digital data coded according to an MPEG standard, the said streams preferably comprising transport trains.

9. Receiver (10, 20, 110) of at least one simultaneous stream of digital data, characterized in that it comprises a time stamping device (40) in accordance with any one of claims 1 to 8.

10. Receiver (10, 20, 110) according to claim 9. characterized in that it comprises a device (33) for recording, on a recording medium (3, 9, 103), at least one of the programs (62, 64) stamped by means of the time stamping device (40).

11. Receiver (10, 20, 110) according to claim 10, characterized in that the said recorded programs requiring in read mode a predetermined clock frequency and a predetermined accuracy with regard to the said frequency, the said receiver comprises a device (50) for reading the said recorded programs, which device is associated with a read clock (2, 8, 132), the reading device (50) being capable of producing the said frequency with the said accuracy by means of the read clock.

12. Receiver (10, 20) according to claim 11, characterized in that the reading device (50) comprises an indicator of locking of the read clock (2, 8) onto clock references of a program received during reading, the said program being received at the said frequency with the said accuracy.

13. Receiver (10, 20) according to one of claims 11 or 12, characterized in that the read clock (2, 8) consists of the stamping clock and in that the reading device (50) comprises a control memory (54) designed to store for the said recorded programs (62, 64) an average value of frequency correction for the said programs (62, 64) with respect to the stamping clock (2, 8), the stamping device (40) being designed to record the said average value in the said control memory (54) and the reading device (50) being designed to use the said average value to control the read clock (2, 8).

14. System for delayed broadcasting comprising at least one receiver (10, 20, 110) in accordance with any one of claims 11 to 13, characterized in that it also comprises at least one recording medium (3, 9, 103) designed to be used by the said recording devices (33) of the said receivers, and at least one link of the said reading devices (50) respectively to at least one broadcasting path for the programs (62, 64) recorded on the said recording medium (3, 9, 103).

15. System for delayed broadcasting according to claim 14, characterized in that the said links comprise at least one connection to an isochronous bus, preferably chosen from among a bus of the IEEE 1394 type (6) and a USB bus in isochronous mode.

16. System for delayed broadcasting according to one of claims 14 or 15, characterized in that the said links comprise at least one connection to a local decoder (7).

17. Process for the time stamping (40) in real time by means of a stamping clock (2, 8, 102) of at least one program (62, 64) of at least one simultaneous stream of digital data received, the said streams comprising packets (71, 72; 73-75; 80-83) associated with at least two programs (61, 62, 64), each of the packets comprising a header containing an indicator (ID) identifying the program associated with the said packet and at least some of the packets (71, 74, 81, 82), the so-called time referenced packets, also comprising clock references (PCR_Wⱼ, PCR_Rᵢ) giving times measured by means of encoding clocks used respectively for the programs (61, 62, 64) associated with the said packets, the said process comprising the steps of:
reading of the indicators (ID) identifying the programs (61, 62, 64) in each of the packets,
selection of one of the said programs (61), the so-called base program,
reading of the clock references (PCR_Wⱼ) of at least some of the time referenced packets (71) of the base program (61), the so-called time utilized packets of the base program,
locking of the stamping clock (2, 8, 102) to the encoding clock used for the base program (61), the so-called base clock, by means of the clock references (PCR_Wⱼ) of the base program (61) which are read by the module (43) for reading the clock references,
and time stamping, by means of the stamping clock (2, 8, 102), of all the packets (74, 75; 80-83) of at least one of the programs (62, 64), the so-called program to be stamped, upon reception of the said packets, the programs to be stamped (62, 64) including at least one program distinct from the base program (61),
characterized in that:
the clock references (PCR_Rᵢ) of at least some of the time referenced packets (74, 81, 82) associated with the programs to be stamped (62, 64) which are distinct from the base program (61), the so-called time utilized packets of the said programs, are also read and
during the time stamping, there are assigned for each of the said programs to be stamped (62, 64):
to each of the time utilized packets (74, 81, 82) of the said program, a time stamp (S) equal to the clock reference (PCR_Rᵢ) of the said packet.
and to each of the packets (75, 80, 83), the so-called current packet, of the said program (62, 64) received between two successive time utilized packets (74, 81, 82) the so-called upstream packet (74, 81) and downstream packet (82), respectively, a time stamp (S) (obtained from at least the clock reference (PCR_Rᵢ) of the upstream packet (74, 81) and of a time increment (C(t)−C(tᵢ)) given by the stamping clock (2, 8, 102) between receptions of the upstream packet (74, 81) and of the current packet (75, 80, 83).

18. String of digital data packets associated with at least two programs, the packets associated with the said programs being intermingled and comprising respectively time stamps (S), some at least of the packets of each of the said programs, the so-called time referenced packets, also comprising clock references (PCP_Rᵢ), the said clock references giving times measured by means of encoding clocks used respectively for the programs associated with the said packets.
characterized in that the time stamps (S) of at least some of the time referenced packets of each of the programs are identical to the clock references (PCR_Rᵢ) of the said packets.
